(19) United States
(12) Patent Application Publication
(10) Pub. No.: US 2012/0083377 A1
(43) Pub. Date: Apr. 5, 2012

(54) ELECTRICAL MACHINE HAVING INTEGRAL DAMPING FOR A TRANSMISSION COMPONENT

(75) Inventors: Steffen Huemmer, Kirchheim/N (DE); Dieter Spaeth, Sachsenheim (DE)

(73) Assignee: ROBERT BOSCH GMBH, Stuttgart (DE)

(21) Appl. No.: 13/260,390

(22) PCT Filed: Mar. 18, 2010
(86) PCT No.: PCT/EP2010/053544

§ 371 Date: Dec. 12, 2011

(30) Foreign Application Priority Data
Mar. 25, 2009 (DE) 10 2009 001 835.2

(51) Int. Cl. F02N 11/00; B29C 45/14; F16H 1/28

(52) U.S. Cl. 475/149; 264/259

(57) ABSTRACT

The invention relates to an electrical machine, in particular a starter for internal combustion engines, having a torque support (40, 50, 72) for a transmission component (44) of a planetary gearing (20) on a housing (54, 62). The torque support (42, 50, 72) comprises symmetrically or asymmetrically designed material weakening (64, 70, 74, 84) enabling a dampening.

### BACKGROUND OF THE INVENTION

FR2 639,701 relates to an under reduction gear, in this case a planetary gear train. In this solution the ring gear of the planetary gear train is supported in a housing by means of elastic elements. Besides the ring gear, the planetary gear train comprises at least two planet gears, which mesh with an external toothing of a sun gear and the internal toothing of the ring gear supported by way of the elastic elements.

US 2003/0177852 A1 discloses a starter, which comprises damping elements of elastic design both for vibrations in an axial direction and for vibrations in a peripheral direction, in order to damp the oscillations generated in the starting phase of the starter. The starter according to US 2003/0177852 A1 also comprises a planetary gear train.

DE 43 02854 C1 relates to a starting device for internal combustion engines. According to DE 43 02854 C1 a starting device for internal combustion engines is disclosed, which comprises a starter motor and an overrunning clutch in the driveline of the starting device. For damping abrupt torque variations, particularly when closing the overrunning clutch, a spring energy accumulator is provided in the driveline. For an effective shock absorption and noise reduction it is essential that the spring energy accumulator have a pre-tensioning torque of 15% to 50% of the short-circuit torque of the starter motor. The ratio of the torsional rigidities of the linear spring energy accumulator to the torsional rigidity of the driveline without spring energy accumulator and relative to the short-circuit moment forms a factor F>4. As also emerges from DE 43 02854 C1, the spring energy accumulator is located between a ring gear of a planetary gear train and a fixed part of the housing of the starting device. The spring energy accumulator comprises multiple spring elements, which are arranged at the circumference of the ring gear and which are supported against the fixed housing part. With at least one projection formed thereon, the spring elements press the ring gear against at least one stop fixed to the housing, creating a pretension acting counter to the drive direction of the starting device. The projections on the ring gear are directed radially outwards and the spring elements are arranged at the outer circumference of the ring gear. The spring elements are helical compression springs or variably curved leaf springs, for example.

For reasons of overall available space, the starters used in internal combustion engines currently in service comprise an internal planetary gear train. Together with the pinion of the starter and the vehicle ring gear an optimum transmission ratio can be set for the starting of an internal combustion engine. Large torque fluctuations act on the planetary gear train. At each compression, in the event of the overrunning clutch closing, a shock load acts in the planetary gear train. Otherwise the torque due to starting of the internal combustion engine acts continuously on the ring gear. Dimensional and positional tolerances of the driveline and of the electric motor of the starter mean that the planetary gear train, in particular the ring gear, is heavily stressed and is exposed to a high degree of wear. In order to safeguard particularly stressed ring gears, and to prolong their service life, these are made not of plastic, as is generally the case, but of sintered metal. In addition, a damping is achieved by means of additional resilient rubber elements, as is disclosed above by the example in FR 2 639, 701, US 2003/0177852 A1 and DE 43 02854 C1.

The use of metal ring gears, produced by the sintering method, having additional rubber spring elements, is expensive firstly in respect of the production of the sintered metal ring gear and secondly in respect of the rubber spring elements additionally used. A further disadvantage of rubber spring elements is that, as a material, rubber exhibits some relaxation over the service life and the elastic characteristics of the rubber material therefore alter gradually but perceptibly over time.

### SUMMARY OF THE INVENTION

The solution proposed according to the invention makes it possible to dispense with the use of sintered metal ring gears having additional rubber spring elements on electrical machines, in particular starters for internal combustion engines, as disclosed by the state of the art. In the solution proposed according to the invention a plastic ring gear can be used for service in a planetary gear train, in which the damping is formed directly at the interface to a drive bearing in order to provide a torque support. The damping can be adjusted through easily made modifications, depending on the application and the level of stresses acting on the ring gear of the planetary gear train.

Ring gears, particularly plastic ring gears that are inexpensive to manufacture, in epicycloidal gear trains, in particular planetary gear trains, can advantageously be used on starters or other electrical machines. The degree of damping that can be brought about by the circumferentially-acting torque support in the form of lug-shaped projections, each formed on the cover plate, is influenced by their design shape and can advantageously be adapted to the torque that is to be supported. The solution proposed according to the invention obviates the need for any use of ring gears for epicycloidal gear trains made from metallic material and hitherto manufactured by the sintering method. A considerable potential saving in terms of the production costs can thereby be achieved. In addition, the solution proposed according to the invention renders the use of additional damping elements made from rubber-elastic material or rubber superfluous, The torque support in relation to the ring gear still remains integrated into the latter, so that no design modifications have to be made, in particular to a starter for internal combustion engines or other electrical machines on which epicycloidal gear trains are used. The damping is achieved by a specific weakening of the torque support of the internal gear in the drive bearing by virtue of the design shape and geometric configuration, exploiting the relaxation capacity of the plastic. A specific tangential movement is introduced.

In particular, slits, whether symmetrical single slits, symmetrical double slits or asymmetrical double slits or specific weakenings in the material by virtue of the geometry of the individual remaining webs and/or the resulting interstices between them, can be made on the cover plate, in which the torque of the ring gear of the planetary gear train is supported. In the solution proposed according to the invention, the torque support due to the slits act as resilient elements, with which a damping capacity can be specifically predefined by the geometry and number of the slits. The torque supports embodied as tangentially resilient elements serve to reduce torque peaks, so that the mechanical stressing, which acts on the ring gear now made of plastic, can be decisively reduced.

Through a specific design shape of the slits characterizing, defining and setting the damping capacity it is advantageously possible to cover the entire performance spectrum, particularly of starters of internal combustion engines. Though the design shape of the torque support with integral damping, it is possible to take account of the overall transmission ratio of a starter for an internal combustion engine or another electrical machine having an epicycloidal gear train through the shape and size of the slits and the specific material weakening.

The torque support for a transmission component of an epicycloidal gear train against a housing is advantageously provided as symmetrically or asymmetrically formed torque support having material weakenings, which absorb load peaks. Multiple torque supports are advantageously formed, distributed circumferentially, on a cover plate and comprise webs. The webs are separated from one another. The webs are formed so that these have support faces, which bear against the housing, in particular against an end face of the housing. In a further configuration of the solution proposed according to the invention the webs bearing against the housing act as leaf springs or flexural bars. The transmission component supported in respect of its torque is a ring gear and the epicycloidal gear train is a planetary gear train. The symmetrical material weakening is embodied as single or multiple slits having at least two webs and at least one interstice formed between them. The asymmetrically formed material weakening comprises webs of different width. In the torque support it is advantageous if the narrower of the two webs, viewed circumferentially, is arranged corresponding to the direction of rotation of the epicycloidal gear train and the broader of the two webs is arranged so that it trails the narrower of the webs in the direction of rotation.

The torque support advantageously comprises face portions separated from one another and facing the housing inner wall. In addition, the proposed torque support in one design variant comprises a notched depression serving as material weakening in the broader of the webs.

The method of manufacture for manufacturing the torque support proposed according to the invention for a transmission component of an epicycloidal gear train is characterized in that circumferentially distributed torque supports, which comprise a symmetrically or asymmetrically formed material weakening, are injection molded onto a cover plate produced in the plastic injection molding method.

### BRIEF DESCRIPTION OF THE DRAWING

The invention will be described in more detail below with reference to the drawing, in which:

FIG. 1 shows the schematic representation of the construction of the electrical circuit of an electrical machine, in particular a starter for internal combustion engines,

FIG. 2 shows a perspective representation of a support of a cover plate accommodating a ring gear of a planetary gear train in the housing according to the state of the art,

FIG. 3 shows a cover plate accommodated on the housing in FIG. 2, having supports according to the state of the art,

FIG. 4 shows a first design variant of a torque support on a cover plate having an asymmetrical slit, which accommodates a ring gear,

FIG. 5 shows a further design variant of the cover plate having a symmetrically formed single slit in the area of the torque support,

FIG. 6 shows a design variant of the torque support on the cover plate having a symmetrical double slit and

FIG. 7 shows a further design variant of the torque support with integral damping formed on a cover plate in an asymmetrical slit with material weakening.

### DETAILED DESCRIPTION

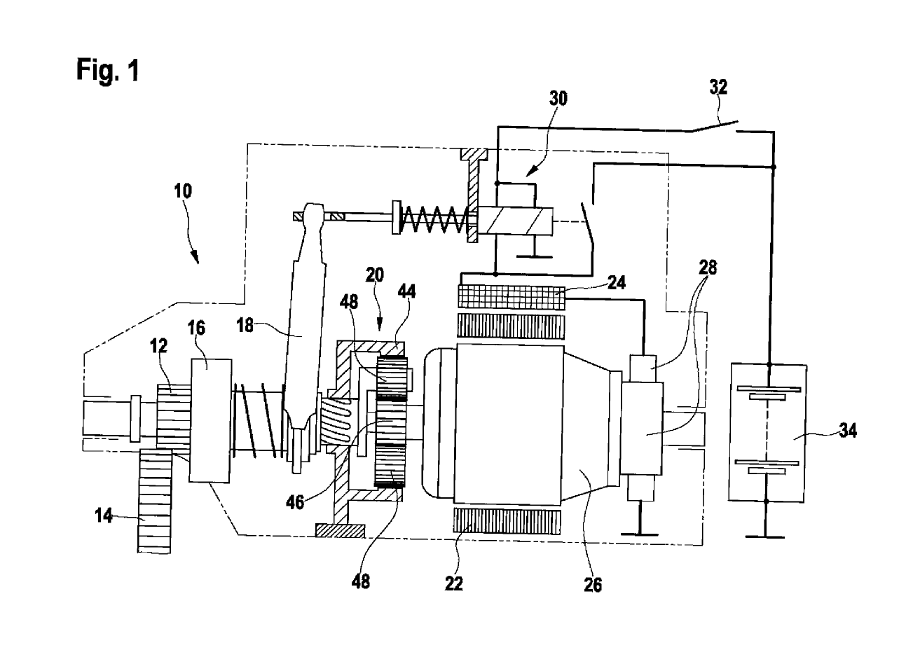

The representation according to FIG. 1 shows a schematic representation of the construction and electrical circuit of a starter for internal combustion engines.

It will be seen from the representation according to FIG. 1 that a starter 10 for an internal combustion engine comprises a pinion 12 mounted on an armature shaft of an armature 26. Said pinion can be made to mesh with a ring gear 2 of the internal combustion engine. The engagement of the pinion 1 into the pinion 12 into the ring gear 14 on the internal combustion engine is brought about by means of an engaging lever 18, which is actuated by a solenoid switch 30 of the starter 10. Situated between the engaging lever 18 actuated via the solenoid switch 30 and the pinion 12 is a roller-type overrunning clutch 16. Also accommodated in the starter 10 is an epicycloidal gear train, in particular a planetary gear train 20. The planetary gear train 20 has the general advantage that despite high attainable transmission ratios it has a very compact construction. With the favorable tooth engagement geometry of the planetary gear train 20, high torques can be transmitted, generating little noise. Outwardly the planetary gear train 20 is free of lateral forces, so that the bearings of the shaft of the armature 26 and the drive shaft are only subjected to low lateral forces even at high power outputs.

The planetary gear train 20 comprises a ring gear 44. It is driven by way of a sun gear 46, which is connected to the shaft of the armature 26 of the electrical drive of the starter 10. At least two planet gears 48 mesh both with the sun gear 46 and with the internal toothing of the ring gear 44. In their rotational movement the planet gears 48, by way of their bearing journals, drive the drive shaft, on which the roller-type overrunning clutch 16 is mounted.

In addition the electrical drive of the starter 10 comprises a pole shoe 22, to which the excitation winding 24 is assigned. The pole shoes 22 enclose an armature 26. The electrical drive of the starter 10 furthermore comprises a commutator 28, on the circumference of which multiple carbon brushes are set. Situated above the electrical drive of the starter 10 is the solenoid switch 30, already motioned, which is actuated by means of a starter switch 32. The starter switch 32 serves to close or open an electrical connection to a battery 34, which is likewise indicated in the schematic representation according to FIG. 1.

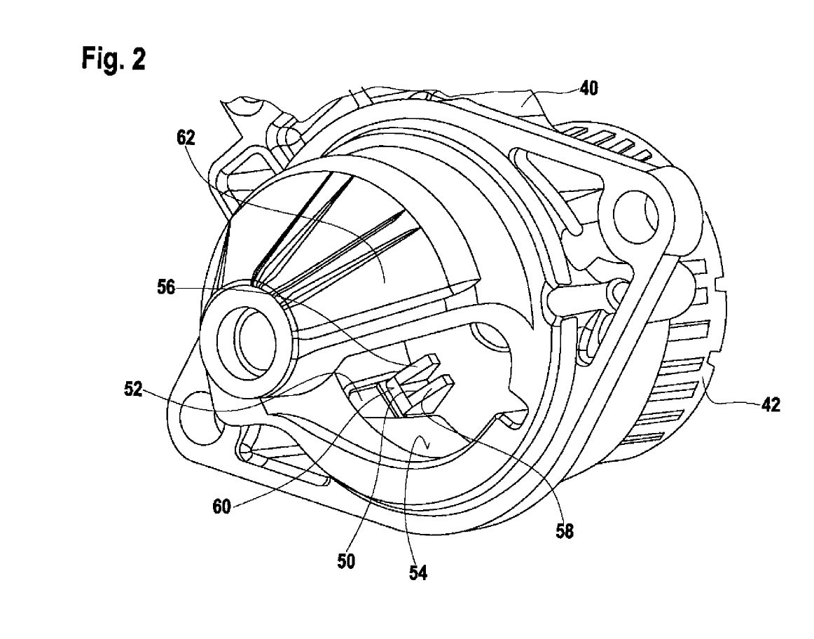

FIG. 2 shows a design variant according to the state of the art, in which a cover plate is supported on a housing.

As can be seen from the representation according to FIG. 2, the cover plate 42 on its inside comprises a number of torque supports 50, hereinafter also referred to simply as supports 50, arranged at the circumference. Only one of these is discernible in the perspective view according to FIG. 2, since the other supports 50 formed on the circumference of the cover plate 42 at the end face facing the housing 62 are hidden by the housing 62. The transmission component, in particular the ring gear 44 of the epicycloidal gear train 20 indicated schematically in FIG. 1, such as a planetary gear train 20, for example, is accommodated in the cover plate 42. The supports projecting beyond the end face of the cup-shaped cover plate 42 extend in have a closed support face 60, together with a first web 56 and a second web 58. The closed support faces 60, supported by the webs 56, 58 extend in receiving slots 52, which are formed on a housing inner wall 54 of the housing 62.

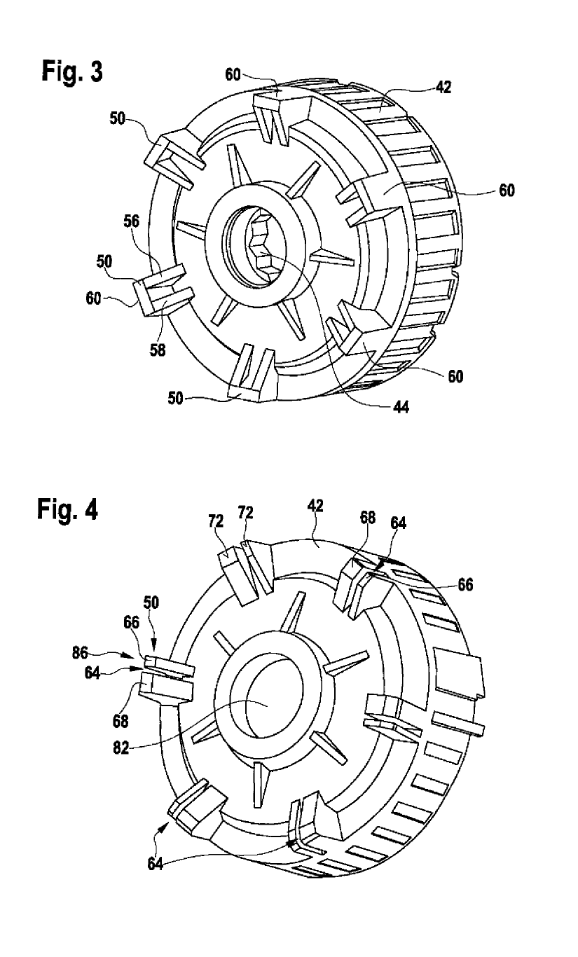

A perspective representation of the cover plate fixed to the housing in FIG. 2 can be seen from the representation according to FIG. 3.

From the perspective view of the cover plate according to FIG. 3 it can be seen that six circumferentially distributed, mounted supports 50, which each have a closed support face 60, are formed on the circumference of the cover plate 42. The closed support face 60, which according to the representation in FIG. 2 extend into the receiving slots 52 on the housing inner wall 54 of the housing 62, are supported by two webs, the first web 56 and the second web 58, likewise spaced at an interval from one another. A transmission component, in particular a ring gear 44, the torque of which is being supported, is situated inside the cover plate 42. Planet gears 48, which mesh with a sun gear 46, are accommodated in the ring gear 44 of the epicycloidal gear train 20 according to FIG. 1.

The closed design of the support face 60, with which the supports 50 extend into receiving slots 52 each formed on the housing inner wall 54 and bear against these, means that the cover plate 42 according to the representation in FIG. 3 has no inherent damping.

A design variant of the solution proposed according to the invention for supporting a transmission component of an epicycloidal gear train can be seen from the representation according to FIG. 4.

As can be seen from the representation according to FIG. 4, supports 50, likewise separated from one another at an interval of 60°, are formed on the end face of the cover plate 42 represented in the figure. In contrast to the solution according to FIG. 3, these supports 50 represented in FIG. 4 are provided with an asymmetrical material weakening 64, in particular a single slit. The asymmetrical material weakening 64 results in one narrower web, cf. reference numeral 66, and one broader web, cf. item 68. On the side facing a drive bearing 40, the webs 66, 68 of the asymmetrical material weakening 64 have support faces 72, with which the support 50 or the supports 50 bear against the end face, for example of a drive bearing 40. The internal friction generated by the contact of the webs 66, 68, acting as flexural bars or as leaf springs, means that torque peaks, which can occur in the operation of a starter or another electrical machine, are damped and reduced, so that instead of a transmission component 44, such as the aforementioned ring gear 44, made from sintered metal, this transmission component 44 can also be made from plastic material having a lower mechanical strength.

As can further be seen from the perspective view according to FIG. 4, the cover plate 42 comprises a central through-opening 82. The asymmetrically formed material weakening 64, in particular a slit of the support 50, gives rise to mutually separated support face portions 86 on this support. In the representation according to FIG. 4 the position of the narrow web 66 and that of the broad web 68 are selected so that this arrangement is intended especially for stresses due to planet gears 48 of a planetary gear train 20 which, viewed from the starting pinion 12 towards the starter motor, move counter-clockwise in the ring gear 44, which is supported in the cover plate 42. The broader of the two webs, that is to say the web 68, is arranged trailing the narrow web 66 in the counter-clockwise rotation of the planet gears 48.

In the case of a clockwise rotation of the planet gears 48, it is to be ensured that, given an asymmetrical material weakening 64, the narrower web 66 lies in front of the broader web 68 of the two webs 66, 68 in the clockwise direction of rotation.

Instead of the six supports 50 formed on the end face of the cover plate 42, which is preferably manufactured by the plastic injection molding method, as represented in FIG. 4, a greater or lesser number of supports 50 may also be injection molded on. The supports 50 may also be provided with a rubber casing specifically in order to influence the damping characteristic.

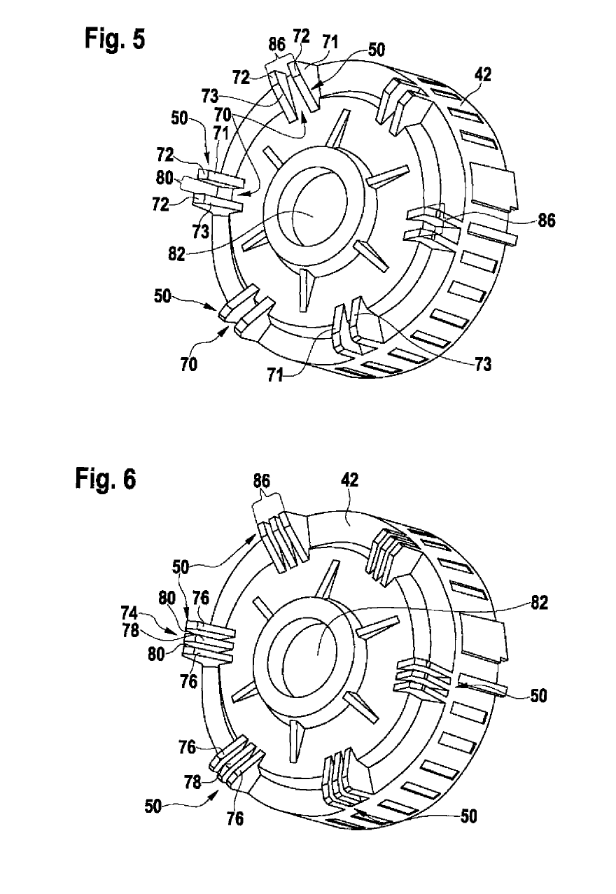

A further design variant of the torque support proposed according to the invention for a transmission component of an epicycloidal gear train can be seen from the representation according to FIG. 5.

FIG. 5 shows that a number of supports, which have a symmetrical material weakening 70, is preferably formed as a slit, is injection molded on the end face of the cover plate 42 produced by preferably by the plastic injection molding method. Each of the symmetrical material weakenings, that is to say each slit 70, comprises a first web 71 and a further web 73. The slit gives rise to the support face portions, cf. item 86, each facing towards the receiving slots 52 on the housing inner wall 54. An interstice, which separates the first web 71 and the second web 73 from one another, is identified by reference numeral 80. Also, according to the second design variant of the solution proposed according to the invention represented in FIG. 5, support faces 72 are formed on the end faces of the first web 71 and the second web 73 respectively, with which the webs 71, 73, separated from one another by the interstice 80, bear against the end face of the drive bearing 40. Also, in the design variant according to FIG. 5 the webs 71 ands 73 have the function of flexural bars or leaf springs and by virtue of the internal friction afford an outstanding damping potential in relation to the end face of the drive bearing 40.

Also, in the solution according to FIG. 5 the interstice 80 forms faces 86 which are separated from one another on the upper side of each of the webs 71, 73 and which owing to the separation from one another rest at circumferential intervals from one another in receiving slots 52 of the housing wall 54 of the housing 62. The number of receiving slots 52 formed in the housing inner wall 54 of the housing 62 advantageously corresponds to the number of supports 50 having either an asymmetrical material weakening 64 or a symmetrical material weakening 70.

A further, third design variant of the torque support proposed according to the invention for a transmission component of an epicycloidal gear train can be seen from the representation according to FIG. 6.

As FIG. 6 shows, supports 50, which are circumferentially separated from one another and which have a symmetrical material weakening 74, which in this third design variant is formed as a double slit, are provided on the end face of the cover plate 42. As can be seen from the representation according to FIG. 6, the individual supports 50 each comprise two outer webs 76 and an inner web 78, situated between these and extending in a radial direction. The outer webs 76 are each separated from the inner web 78 by slits 80. The slit width is smaller, however, compared to the slit width in the second design variant represented in FIG. 5, having a symmetrical slit 70 of the supports 50. In the third design variant according to FIG. 6 the material weakening 74 symmetrically formed as a double slit on the upper side of the supports 50 gives rise to three support face portions 86, which are separated from one another and which, when the cover plate 42 is fitted to the housing 62 according to the design variant in FIG. 6, rest on the face of the receiving slots 52 of the housing inner wall 54.

The symmetrical material weakening 74 in the area of the supports 50 represented in the third design variant according to FIG. 6 also serves to achieve a specific weakening of the support points of the ring gear 44, which is accommodated in the cover plate 42 and which can now be made of plastic. The solution proposed according to the invention eliminates the need for additional spring elements of rubber-elastic material. The solution proposed according to the invention, the relaxation capacity of the plastic material from which the cover plate 42 is produced, preferably by the plastic injection molding method, out. The individual webs, cf. item 66, 68 in FIG. 4, items 71, 73 in FIG. 5 and the items 76, 78 in FIG. 6, serve as resilient elements, such as leaf springs or flexural bars, for example, having a very high damping potential, so that abruptly occurring torque loads and support for these can be absorbed by way of the internal friction on the end face of the drive bearing 40—to name one example.

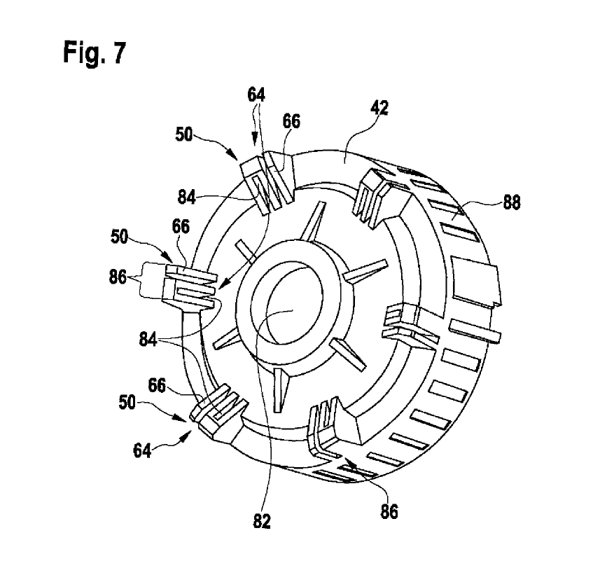

The representation according to FIG. 7 shows a further, fourth design variant of the torque support proposed according to the invention.

According to the solution in FIG. 7, besides the narrow web 66, the supports 50, which are formed at a 60° interval on the end face of the cover plate 42, comprise a broad web 68, running in which is a notched depression 84. This notched depression 84 serves to weaken the broader slit 68. Compared to the design variant according to FIG. 4, the fourth design variant of the solution proposed according to the invention represented in FIG. 7 also features an asymmetrically formed material weakening 64, with the difference that the broader of the webs 66, 68 comprises a notched depression 84. The notched depression 84, however, does not extend up to the support face portions 86 on the upper side of the supports 50. As in the design variants according to FIGS. 4, 5 and 6, the cover plate 42 comprises a through-opening 82, through which the armature shaft of the starter 10 extends. The reference numeral 88 denotes a casing of the cover plate 42, which is preferably produced by the plastic injection molding method. In this production the supports 50 configured in different design variants according to FIGS. 4, 5 and 6 can be directly molded on the cover plate 42 in one operation, without the need for further finishing of the latter. Also, in the fourth design variant of the solution proposed according to the invention represented in FIG. 7 the support faces 72, which bear against the end face of the drive bearing 40 and are pre-tensioned against this face, are situated on the side of the webs 66, 68 facing the end face of the drive bearing 40.

Common to all design variants of the torque support proposed according to the invention according to FIGS. 4 to 7 is the fact that the supports 50 specifically have through material weakenings, preferably embodied as slits, forming the webs 66, 68, 71, 73, 76, 78, which function as flexural bars or leaf springs. Under torque stresses, these act as damping between the cover plate 42, in which the ring gear 44 is accommodated, and the housing 62.

1. An electrical machine having a torque support (42, 50, 72) for a transmission component (44) of an epicycloidal gear train (20) against a housing (54, 62), characterized in that the symmetrically or asymmetrically formed torque support (42, 50, 72) comprises material weakenings (64, 70, 74, 84), which absorb load peaks.

2. The electrical machine as claimed in claim 1, characterized in that multiple torque supports (50, 72) are formed, distributed circumferentially on a cover plate (42), and comprise webs (66, 68; 71, 73; 76, 78).

3. The electrical machine as claimed in claim 2, characterized in that the webs (66, 68; 71, 73; 76, 78) are separated from one another.

4. The electrical machine as claimed in claim 2, characterized in that the webs (66, 68; 71, 73; 76, 78) comprise support faces (72), which bear against the housing (54, 62).

5. The electrical machine as claimed in claim 2, characterized in that the webs (66, 68; 71, 73; 76, 78) bearing against the housing (54, 62) act as leaf springs or as flexural bars.

6. The electrical machine as claimed in claim 1, characterized in that transmission component (44) is a ring gear and the epicycloidal gear train (20) is a planetary gear train.

7. The electrical machine as claimed in claim 1, characterized in that a symmetrical material weakening (70, 74) includes a single or multiple slit having at least two webs (66, 68; 71, 73; 76, 78) and at least one interstice (80) lying between the two webs.

8. The electrical machine as claimed in claim 1, characterized in that an asymmetrical material weakening (64) comprises webs (66, 68) of different width.

9. The electrical machine as claimed in claim 8, characterized in that, viewed circumferentially, a narrower of the webs (66, 68) is arranged corresponding to the direction of rotation of the epicycloidal gear train (20) and a broader of the webs (66, 68) is arranged so that it trails the narrower of the webs (66, 68) in the direction of rotation.

10. The electrical machine as claimed in claim 1, characterized in that the torque supports (50) comprises face portions (86) separated from one another and facing a housing inner wall (54).

11. The electrical machine as claimed in claim 8, characterized in that a notched depression (84) is introduced as material weakening in a broader of the webs (66, 68).

12. A method for manufacturing a torque support (42, 50, 72) of a transmission component (44) of an epicycloidal gear train (20) for an electrical machine, characterized in that circumferentially distributed torque supports (50, 72), which comprise a symmetrically or asymmetrically formed material weakening (64, 70, 74, 84), are injection molded onto a cover plate (42) produced in a plastic injection molding method.

13. The electrical machine as claimed in claim 1, characterized in that the machine is a starter for an internal combustion engine.

14. The electrical machine as claimed in claim 2, characterized in that the webs (66, 68; 71, 73; 76, 78) comprise support faces (72), which bear against an end face of the housing.
